(19) United States
(12) Patent Application Publication
(10) Pub. No.: US 2021/0158720 A1
(43) Pub. Date: May 27, 2021

(54) AUTOMATIC DIGITAL BADGE UPDATE SYSTEM

(71) Applicant: INTERNATIONAL BUSINESS MACHINES CORPORATION, Armonk, NY (US)

(72) Inventors: Paul R. Bastide, Ashland, MA (US); Fang Lu, Billerica, MA (US); Matthew E. Broomhall, Goffstown, NH (US); Robert E. Loredo, North Miami Beach, FL (US)

(21) Appl. No.: 16/693,882

(22) Filed: Nov. 25, 2019

(51) Int. Cl. G09B 19/00

(52) U.S. Cl. CPC G09B 19/00

(57) ABSTRACT

A method, computer system, and computer program product for automatic digital badge updates are provided. The embodiment may include monitoring day-to-day activities of a user. The embodiment may also include deriving a current level of expertise for the user based on the day-to-day activities. The embodiment may further include crowdsourcing an expected level of expertise in a different knowledge domain. The embodiment may also include comparing the current level of expertise with the expected level of expertise. The embodiment may further include modifying a color of a digital badge associated with the user based on the comparison between the current level of expertise and the expected level of expertise.

### BACKGROUND

The present invention relates, generally, to the field of computing, and more particularly to digital badges.

A digital badge is an indicator of accomplishment, skill, quality or interest that a user may earn in many learning environments. Digital badges have become powerful tools to identify or validate a user's knowledge, skills, and competencies that may be attained everywhere at every age. Often, digital badge platforms allow organizations to create, issue, earn and display digital badges on user websites, social media pages, and resumes. Digital badges may be used to encourage participation by recognizing the participants as digital badges offer a new pathway of lifelong learning separate from the traditional, formalized academic pathway and capture the complete learning path. Such a learning path travels with a user wherever the user decides to display the badge. Digital badges may also contain information as to assessment, evidence and other metadata required by each badge.

### SUMMARY

According to one embodiment, a method, computer system, and computer program product for automatic digital badge updates are provided. The embodiment may include monitoring day-to-day activities of a user. The embodiment may also include deriving a current level of expertise for the user based on the day-to-day activities. The embodiment may further include crowdsourcing an expected level of expertise in a different knowledge domain. The embodiment may also include comparing the current level of expertise with the expected level of expertise. The embodiment may further include modifying a color of a digital badge associated with the user based on the comparison between the current level of expertise and the expected level of expertise.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at6 least one embodiment;

FIG. 2 is an operational flowchart illustrating an automatic digital badge update process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to digital badges. The following described exemplary embodiments provide a system, method, and program product to analyze user's day to day activities and domain knowledge used through such activities and the frequency and depth of such domain knowledge to assess the user's current level of expertise or skills with respect to particular domain knowledge and update the user's current digital badges using color scales. Therefore, the present embodiment has the capacity to improve the technical field of digital badges by evaluating and calculating the accuracy of the user's expertise.

As previously described, a digital badge is an indicator of accomplishment, skill, quality or interest that a user may earn in many learning environments. Digital badges have become powerful tools to identify or validate a user's knowledge, skills, and competencies that may be attained everywhere at every age. Often, digital badge platforms allow organizations to create, issue, earn and display digital badges on user websites, social media pages, and resumes. Digital badges may be used to encourage participation by recognizing the participants as digital badges offer a new pathway of lifelong learning separate from the traditional, formalized academic pathway and capture the complete learning path. Such a learning path travels with a user wherever the user decides to display the badge. Digital badges may also contain information as to assessment, evidence and other metadata required by each badge.

Digital badges have become more and more popular and different badges may reflect different skillsets a user may possess. However, a digital badge may not reflect whether the user's skillsets are truly up to date as the time passes. As such, it may be advantageous to, among other things, implement a system capable of reflecting a user's true skillsets across different knowledge bases, and thereby motivating the user to consider updating skillsets based on the expectations of the current job.

According to one embodiment, the present invention may analyze a user's day-to-day activities and domain knowledge and frequency and depth of each domain knowledge to associate the frequency and depth scores with existing digital badges the user may have earned. The present invention may also update the color scales of the digital badges using either fade-in or fade-out effects. The present invention may further recommend new digital badges the user may be able to earn based on the new domain knowledge the user may have acquired.

The present invention may be a system, a method, and/or a computer program product at any possible technical detail level of integration. The computer program product may include the computer-readable storage medium (or media) having the computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or another device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for analyzing a user's day-to-day activities and domain knowledge and frequency and depth of each domain knowledge to update the currency of the user's existing digital badges.

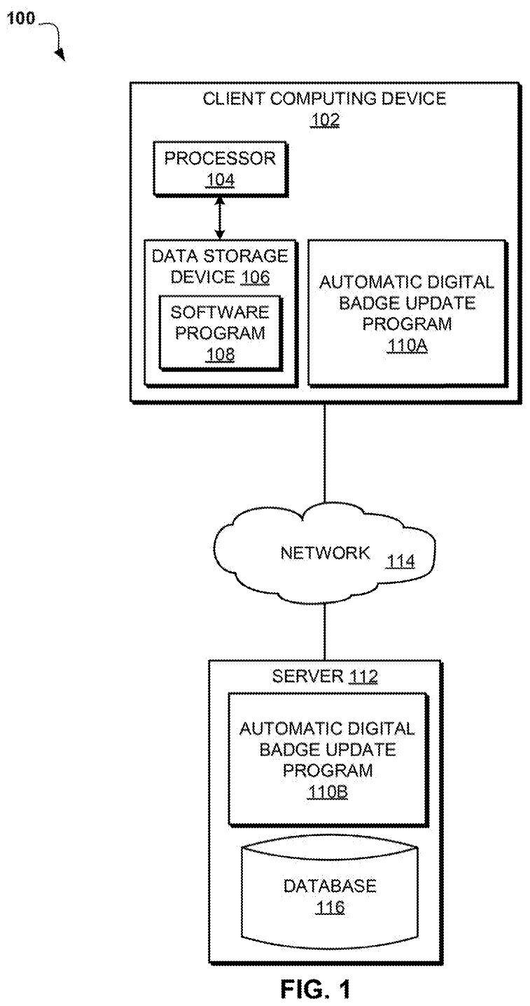

Referring to FIG. 1, an exemplary networked computer environment 100 is depicted according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

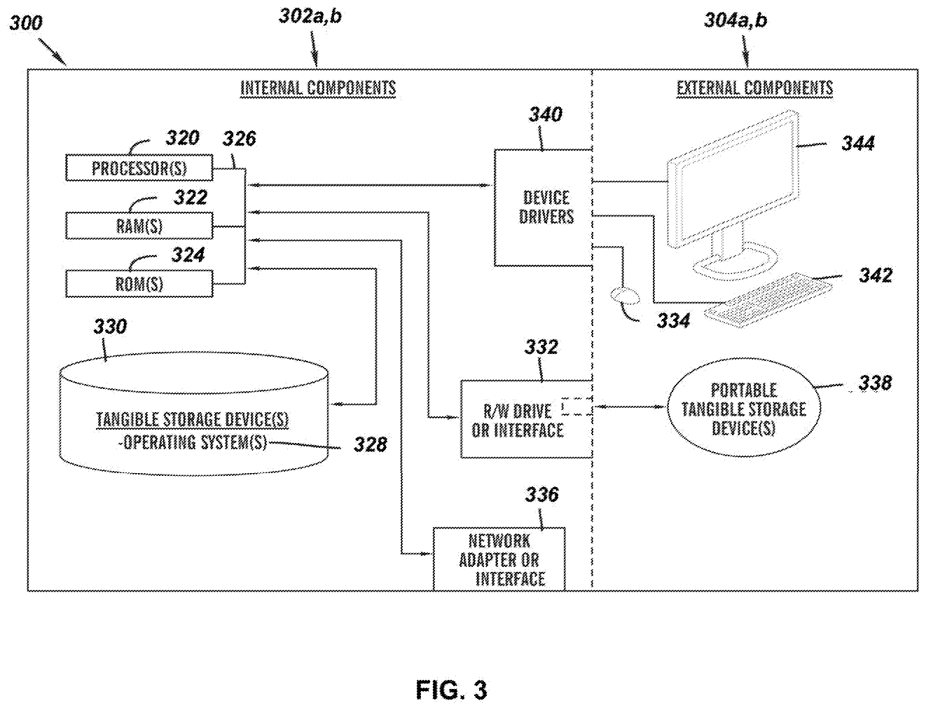

Client computing device 102 may include a processor 104 and a data storage device 106 that is enabled to host and run a software program 108 and an automatic digital badge update program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running an automatic digital badge update program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

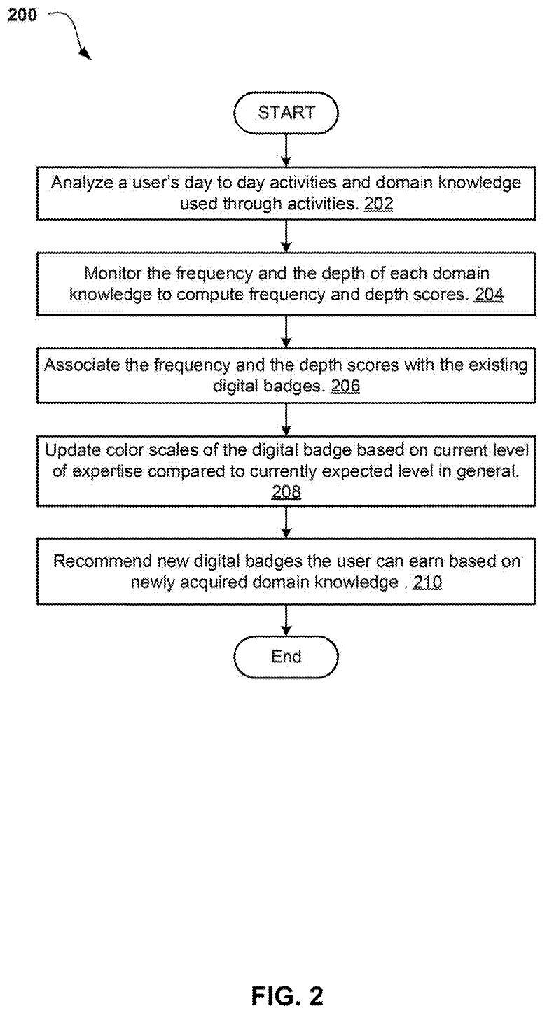

According to the present embodiment, the automatic digital badge update program 110A, 110B may be a program capable of analyzing a user's day-to-day activities and comparing the user's current level of expertise with the currently generalized and expected level of expertise based on the crowd-sourced general level of expertise in different knowledge domains. The automatic digital badge updating process is explained in further detail below with respect to FIG. 2.

Referring to FIG. 2, an operational flowchart illustrating an automatic digital badge updating process 200 is depicted according to at least one embodiment. At 202, the automatic digital badge update program 110A, 110B analyzes a user's day-to-day activities and domain knowledge used through such activities. According to one embodiment, the automatic digital badge update program 110A, 110B may monitor software and hardware that the user use for day to day activities and determine the frequency of such use. The automatic digital badge update program 110A, 110B may also determine the knowledge or skill levels required to conduct the above activities using such software and hardware. For example, if a user is skillful in using a particular feature or tool embedded in particular software, the automatic digital badge update program 110A, 110B may monitor and analyze the content of the end products produced by the user using the particular tool of the software and may determine the knowledge and level of the skill of the user based on comparison to the data of the similar domain knowledge stored in a database. The automatic digital badge update program 110A,110B may further analyze the objectives of the user access of each tool or software. For example, if a user regularly uses spreadsheet software to make graphs associated with a certain dataset for the user's daily job function, the automatic digital badge update program 110A, 110B may determine that the objective of the software used is to conduct data analysis and summarize data in a graph.

At 204, the automatic digital badge update program 110A, 110B monitors the frequency and the depth of each domain knowledge to compute frequency and depth scores. According to one embodiment, the automatic digital badge update program 110A, 110B may keep track of the frequency of user access to particular tools. For example, if a user uses a spreadsheet software and a bar graph tool several times a day for the user's job tasks, the automatic digital badge update program 110A, 110B may keep track of the exact number of occasions when the user actually uses the bar graph tool. Further, if a user is a software engineer and frequently uses a particular programming language for the user's job tasks, the digital badge update program 110A, 110B may monitor the frequency of the user's access to the related programming software. In at least one other embodiment, the automatic digital badge update program 110A, 110B may determine the complexity of each task the user performs using a particular tool or software. In the above example, if a user's programming tasks involve relatively long and complex codes, the automatic digital badge update program 110A, 110B may determine that the knowledge and the skill level of the user are relatively high. The depth scores may be computed based on the complexity of the code being analyzed and the skill level needed to review the code or solve a problem with the code.

At 206, the automatic digital badge update program 110A, 110B associates the frequency and the depth scores with the existing digital badges. According to one embodiment, the automatic digital badge update program 110A, 110B may retrieve and parse a user's existing digital badges from the user's profile, email or social media sites. Also, skill information associated with the user may be received. Such skill information may include existing data value-related to a particular skill (e.g. certificate level, license level, language test score, etc.) and already identified skill level. The automatic digital badge update program 110A, 110B may determine the level of expertise for a user based on the monitored frequency and level of knowledge or skills needed for a task involving each tool. In at least one embodiment, such level of expertise may be expressed in numeric values (e.g. on a scale of 0 to 100) or in words (e.g. low, medium, high). The automatic digital badge update program 110A, 110B may then compare the analyzed skill levels with the stored skill information associated with the existing digital badges to determine whether the existing skill information or digital badge information needs to be updated. In yet another embodiment, the automatic digital badge update program 110A, 110B may determine the frequency and the depth score when the analyzed expertise level meets a preconfigured criterion or score.

At 208, the automatic digital badge update program 110A, 110B updates color scales of the digital badges based on the user current level of the expertise compared to the generally expected level of the expertise. According to one embodiment, the automatic digital badge update program 110A, 110B may change the color of the existing digital badges if the automatic digital badge update program 110A, 110B determines that a user has increased or decreased the associated skillset. The associated skillset may be determined to be increased if a user has learned new skillset or taken certain training courses related to the skillset. On the other hand, the associated skillset may be determined to be decreased if certain skillset has not been used for a long time and may the skillset has deteriorated over the time. For example, the automatic digital badge update program 110A, 110B may change the color of a digital badge to blue or green when the associated skillset has increased or changed the color to red or yellow when the associated skillset has decreased. The automatic digital badge update program 110A, 110B may further compare a user's expertise level with the currently generalized expertise level based on crowdsourced generally expected level of expertise in different knowledge domains. The generally expected level may be badge viewer specific, based on the language indicative of usage.

At 210, the automatic digital badge update program 110A, 110B recommends new digital badges that the user can earn based on newly acquired domain knowledge. According to one embodiment, the automatic digital badge update program 110A, 110B may determine other skillsets a user has gained when analyzing the user's day-to-day activities and the use of particular tools or software. For example, when a software engineer starts using a different programming language to perform daily job tasks, the automatic digital badge update program 110A, 110B may determine that the user has gained different skillsets and recommend to the user that a new digital badge may be added to the user profile.

It may be appreciated that FIGS. 2 provides only an illustration of one implementation and does not imply any limitations with regard to how different embodiments may be implemented. Many modifications to the depicted environments may be made based on design and implementation requirements. For example, in at least one embodiment, the automatic digital badge update program 110A, 110B may include the currency or up-to-dateness of a particular user skillset. The automatic digital badge update program 110A, 110B may further recommend whether a badge is significant enough to warrant renewal or allow to expire when time constraints exceed the amount allowed to complete renewal process.

FIG. 3 is a block diagram of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smartphone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the automatic digital badge update program 110A in the client computing device 102 and the automatic digital badge update program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes an R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as an automatic digital badge update program 110A, 110B can be stored on one or more of the respective portable computer-readable tangible storage devices 338, read via the respective R/W drive or interface 332 and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the automatic digital badge update program 110A in the client computing device 102 and the automatic digital badge update program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the automatic digital badge update program 110A in the client computing device 102 and the automatic digital badge update program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

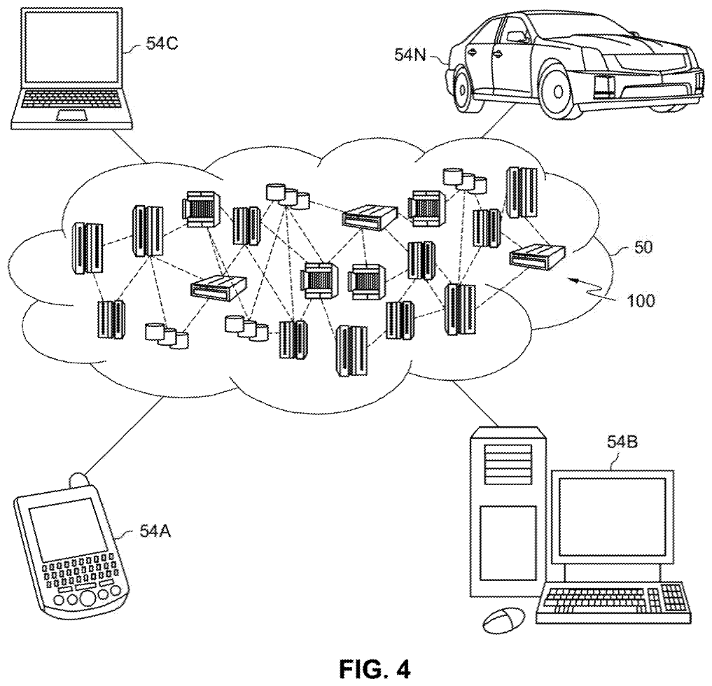

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

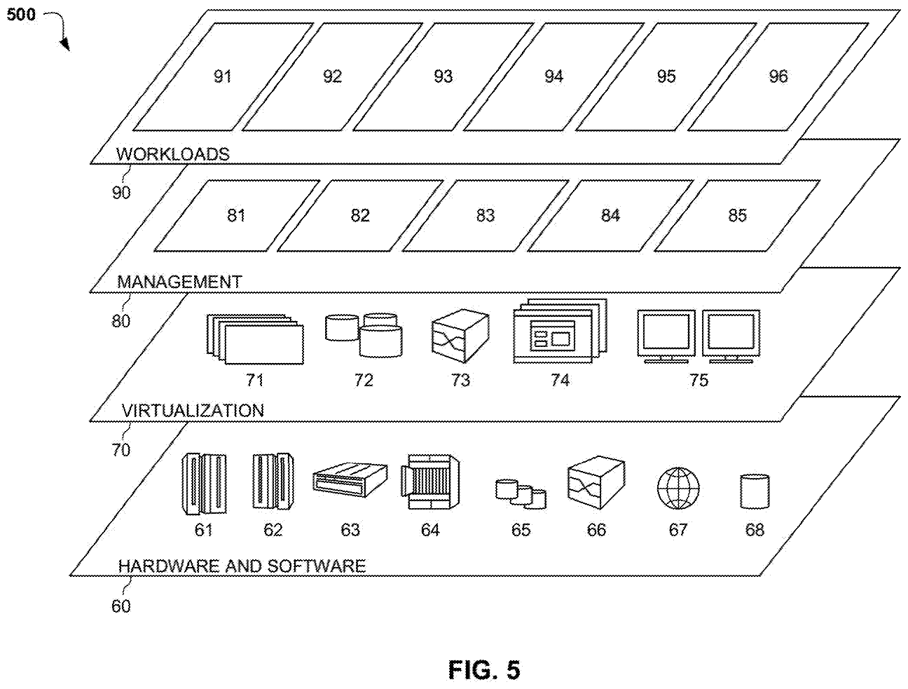

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and automatic digital badge update 96. Automatic digital badge update 96 may relate to updating color scales of digital badges based on an assessment of accuracy of such digital badges.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for automatic digital badge update, the method comprising:
monitoring day-to-day activities of a user;
deriving a current level of expertise for the user based on the day-to-day activities;
crowdsourcing an expected level of expertise in a different knowledge domain;
comparing the current level of expertise with the expected level of expertise; and
modifying a color of a digital badge associated with the user based on the comparison between the current level of expertise and the expected level of expertise.

2. The method of claim 1, wherein the current level of expertise for the user is derived from a complexity of the day-to-day activities of the user.

3. The method of claim 1, wherein the current level of expertise for the user is derived from a frequency of the day-to-day activities of the user.

4. The method of claim 1, further comprising:
brightening the color of the digital badge in response to the current level of expertise being greater than the expected level of expertise.

5. The method of claim 1, further comprising:
fading the color of the digital badge in response to the current level of expertise being less than the expected level of expertise.

6. The method of claim 1, further comprising:
recommending new digital badges that the user can earn based on newly acquired knowledge or attained skills.

7. The method of claim 1, further comprising:
notifying the user of a currentness of previously attained skills associated with the digital badge.

8. A computer system for automatic digital badge update, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
monitoring day-to-day activities of a user;
deriving a current level of expertise for the user based on the day-to-day activities;
crowdsourcing an expected level of expertise in a different knowledge domain;
comparing the current level of expertise with the expected level of expertise; and
modifying a color of a digital badge associated with the user based on the comparison between the current level of expertise and the expected level of expertise.

9. The computer system of claim 8, wherein the current level of expertise for the user is derived from a complexity of the day-to-day activities of the user.

10. The computer system of claim 8, wherein the current level of expertise for the user is derived from a frequency of the day-to-day activities of the user.

11. The computer system of claim 8, further comprising:
brightening the color of the digital badge in response to the current level of expertise being greater than the expected level of expertise.

12. The computer system of claim 8, further comprising:
fading the color of the digital badge in response to the current level of expertise being less than the expected level of expertise.

13. The computer system of claim 8, further comprising:
recommending new digital badges that the user can earn based on newly acquired knowledge or attained skills.

14. The computer system of claim 8, further comprising:
notifying the user of a currentness of previously attained skills associated with the digital badge.

15. A computer program product for automatic digital badge update, the computer program product comprising:
one or more computer-readable tangible storage media and program instructions stored on at least one of the one or more tangible storage media, the program instructions executable by a processor of a computer to perform a method, the method comprising:
monitoring day-to-day activities of a user;
deriving a current level of expertise for the user based on the day-to-day activities;
crowdsourcing an expected level of expertise in a different knowledge domain;
comparing the current level of expertise with the expected level of expertise; and
modifying a color of a digital badge associated with the user based on the comparison between the current level of expertise and the expected level of expertise.

16. The computer program product of claim 15, wherein the current level of expertise for the user is derived from a complexity of the day-to-day activities of the user.

17. The computer program product of claim 15, wherein the current level of expertise for the user is derived from a frequency of the day-to-day activities of the user.

18. The computer program product of claim 15, further comprising:
brightening the color of the digital badge in response to the current level of expertise being greater than the expected level of expertise.

19. The computer program product of claim 15, further comprising:
fading the color of the digital badge in response to the current level of expertise being less than the expected level of expertise.

20. The computer program product of claim 15, further comprising:
recommending new digital badges that the user can earn based on newly acquired knowledge or attained skills.
